(19) United States
(12) Patent Application Publication
(10) Pub. No.: US 2012/0155426 A1
(43) Pub. Date: Jun. 21, 2012

(54) METHOD AND APPARATUS FOR HANDLING SESSION MIGRATION BY PREDICTING MOVEMENTS OF A MOBILE DEVICE

(75) Inventors: Anurag Verma, Bangalore (IN); Jeelan Poola, Bangalore (IN); Hari Sharma, Bangalore (IN)

(73) Assignee: SYMBOL TECHNOLOGIES, INC., Schaumburg, IL (US)

(21) Appl. No.: 12/969,032

(22) Filed: Dec. 15, 2010

(51) Int. Cl. H04W 4/00

(52) U.S. Cl. 370/331

(57) ABSTRACT

A method is disclosed for seamlessly handing over a mobile device from one access point to another access point in a wireless network. The method includes predicting future movement of a mobile device from an associated coverage area to another coverage area within a predefined time period. The method also includes identifying candidate access points to whom the mobile device can connect after the mobile device leaves the associated coverage area and sending a predefined number of communications sessions for the mobile device to the candidate access points. The method further includes transmitting a neighbor report to the mobile device in response to indication of movement by the mobile device to the other coverage area and, when the mobile device roams, transmitting any remaining communications sessions for the mobile device to a second access.

### FIELD OF THE DISCLOSURE

The present disclosure relates generally to movements of a mobile device and more particularly to predicting movements of the mobile device to seamlessly handover the mobile device from one access point to another.

### BACKGROUND

A Wireless Local Area Network (WLAN) includes a number of infrastructure devices, such as access points. Each access point is configured to provide network coverage to wireless devices in a specific geographical area of the WLAN. When a mobile device enters the WLAN coverage area, it connects to an access point (first access point) and establishes a set of communications sessions with the first access point. The communications sessions are maintained by the first access point and are used to keep track of network connections and communications associated with the mobile device. For example, when the mobile device initially connects to the first access point, a firewall in the first access point is configured to permit or deny access to the WLAN. In certain implementations, the firewall permits access to the WLAN by verifying information in packets sent from the mobile device to the first access point. The verified information is included in the mobile device's communications sessions.

If the mobile device roams to another geographical location in the WLAN where a second access point provides network coverage, the mobile device disconnects from the first access point and connects to the second access point. The second access point sends a roaming event notification to the first access point. In response to the notification, the first access point transmits the mobile device's communications sessions to the second access point. This allows the mobile device to receive services from the second access point without having to establish separate communications sessions with the second access point. Although the mobile device is configured to transmit packets to the second access point immediately upon connection to the second access point, the second access point cannot transmit packets received from the mobile device prior to receiving mobile device's communications sessions from the first access point. The delay associated with sending the mobile device's communications sessions from the first access point to the second access point may last from, for example 2 seconds up to 1 minute, depending on the number of communications sessions maintained by the first access point.

In certain protocols, for example a Transport Control Protocol (TCP) protocol, packets transmitted from the mobile device during the delay associated with sending the mobile device's communications sessions to the second access point need to be re-transmitted. This uses up network resources. In addition, although in some protocols packet re-transmission may be unnoticeable to a user, in other protocols this can result in degradation of service. For example, protocols used to transmit voice data are latency sensitive and packet re-transmission typically results in a noticeable degradation of voice quality.

Accordingly, there is a need to seamlessly handover the mobile device from one access point to another in the WLAN.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a WLAN whose operation includes implementing schemes for eliminating delays associated with handover of a mobile device in accordance with some embodiments.

FIG. 2 is a flowchart of a method for predicting movements of a mobile device in coverage areas of a WLAN in accordance with some embodiments.

FIG. 3 is a flowchart of a method for processing information associated with a roaming mobile device at candidate access points in accordance with some embodiments.

FIG. 4 is a block diagram of an access point used in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Some embodiments are directed to methods and apparatuses for seamlessly handing over a mobile device from one access point to another access point in a wireless network. The method includes predicting, by a first access point, future movement of a mobile device from an associated coverage area to another coverage area within a predefined time period. The method also includes identifying, by the first access point, candidate access points to whom the mobile device can connect after the mobile device leaves the associated coverage area and sending a predefined number of communications sessions for the mobile device to the candidate access points. The method further includes transmitting, by the first access point, a neighbor report to the mobile device in response to indication of movement by the mobile device to the other coverage area and, when the mobile device roams, transmitting any remaining communications sessions for the mobile device to a second access point which is one of the candidate access points to whom the mobile device is connected, thereby seamlessly handing over the mobile device from the first access point to the second access point.

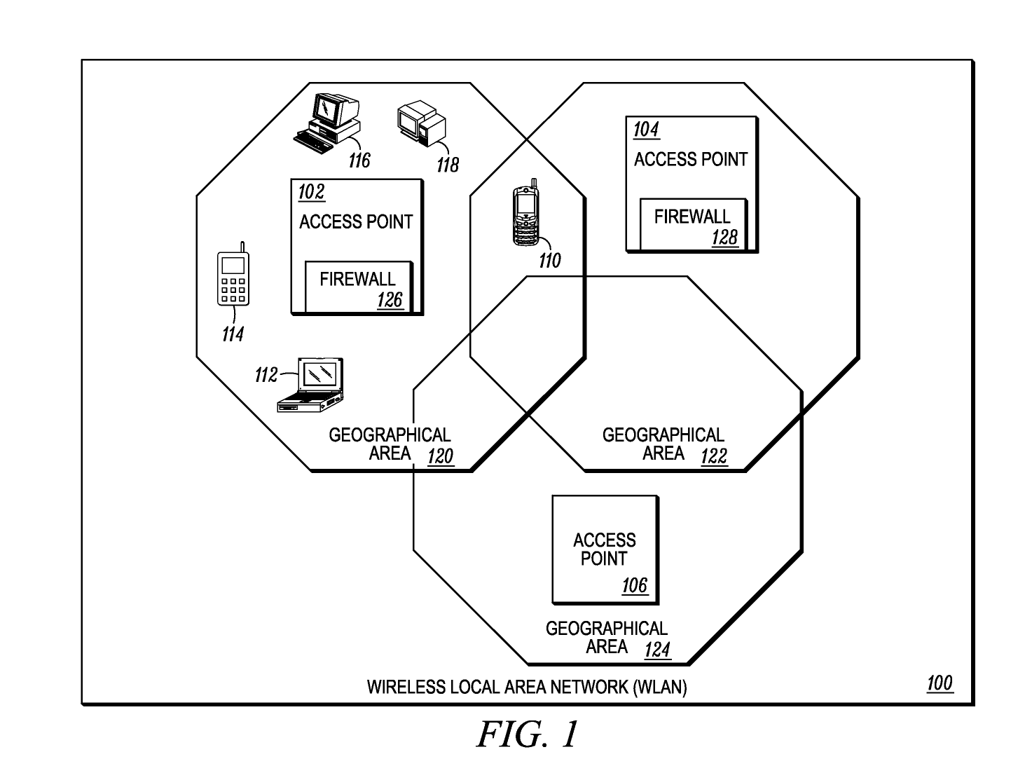

FIG. 1 is a block diagram of a Wireless Local Area Network (WLAN) 100 whose operation includes implementing schemes for eliminating delays associated with handover of a mobile device. In some embodiments, WLAN 100 employs a number of access points 102-106, each of which is configured to provide coverage to a predefined geographical area 120-124. WLAN 100 operates, for example, using Institute of Electrical and Electronics Engineers (IEEE) 802.11 and the like. (For this and any (IEEE) standards recited herein, see: http://standards.ieee.org/getieee802/index.html or contact the IEEE at IEEE, 445 Hoes Lane, PO Box 1331, Piscataway, N.J. 08855-1331, USA.) An access point 102-106 employed in WLAN 100 connects wireless devices 110-118 within the WLAN to each other. Access points 102-106 can also serve as points of interconnection between WLAN 100 and a fixed wire network. Each access point 102-106 can serve multiple wireless devices within its associated geographical coverage area 120-124. Wireless devices may include relatively stationary devices, such as desktop computers 116 and 118, or mobile devices 110-114, such as laptops, cellular telephones, portable game players, or radios. As mobile devices 110-114 move beyond the communication range of one access point, they are automatically handed over to another access point according to the network standard implemented by the WLAN. It should be appreciated that other components of WLAN 100 are not shown for the sake of simplicity.

Each access point 102-106 may include a firewall which is configured to block unauthorized access to WLAN 100. When, for example, mobile device 110 connects to access point 102, firewall 126 is configured to permit or deny network transmissions associated with mobile device 110 based upon a set of predefined rules and other criteria. Firewall 126 typically performs extensive checks on the first packet transmitted from mobile device 110. Upon authenticating mobile device 110, firewall 126 typically performs relatively minimal checks on subsequent packets from mobile device 110. During the initial connection between mobile device 110 and access point 102, communications sessions are established and access point 102 maintains session information for the newly established communications sessions. For example, the session information may include information obtained by firewall 126 during authentication of mobile device 110. The firewall information is simply an example of information that may be included in the session information. Depending on the communications protocol(s) used by devices on WLAN 100, the session information may also include other information that is necessary in establishing network connections and communications sessions between wireless devices 110-118 and access points 102-106.

When mobile device 110 moves from geographical area 120 to another geographical area, for example geographical area 122 covered by access point 104, mobile device 110 disconnects from access point 102 and connects to access point 104. To ensure a fast handover of mobile device 110 from access point 102 to access point 104, according to some networking protocols, access point 104 may not be required to establish new communications sessions with mobile device 110. For example, a firewall 128 in access point 104 may not have to rerun firewall related checks for mobile device 110. Instead, the previously established communications sessions with access point 102 are transmitted from access point 102 to access point 104.

To avoid delays associated with transmitting the communications sessions to access point 104 after mobile device 110 has connected to access point 104, in some embodiments, access point 102 is configured to anticipate the mobile device's movement before mobile device 110 moves to a location outside access point's 102 geographical area 120. Therefore, before mobile device 110 roams to geographical area 122, access point 102 is configured to predict that mobile device 110 is about to roam outside of geographical area 120. For example, access point 102 is configured to predict that mobile device 110 is about to move out of its geographical area if signals from mobile device 110 for a predefined number of packets is below a predefined threshold. The predefined threshold is fixed to an optimal value for mobile devices from different vendors. For example, a typical signal is considered below the threshold if it below ten decibel (10 db) range. Once the signal strength from mobile device 110 for the predefined number of packets is determined to be below the threshold, access point 102 is configured to transmit a beacon request to mobile device 110. The beacon request is a request to the mobile device to obtain a list of access points that are in mobile device's 110 communications range. Mobile device 110 responds to the beacon request by transmitting a beacon report which includes a list of access points that are capable of transmitting signals to the mobile device's current location.

It should be noted that if, during a period when mobile device 110 is transmitting signals below the threshold, mobile device 110 transmits an intermediate signal which is higher than the predefined threshold, access point 102 is configured to reset a count for determining the number of signals transmitted from mobile device 110 that are below the threshold. In some embodiments, the intermediate signal suggests a temporary disturbance in the mobile device's signal and it is an indication that mobile device 110 is less likely to roam outside of geographical area 120.

Based on the list of access points in the beacon report from mobile device 110, access point 102 creates a neighbor report. The neighbor report includes a list of access points within the mobile device 110 communications range. The neighbor list is ordered according to how likely mobile device 110 is to connect to an access point in the list. Information associated with each access point in the list that is used in ordering the list includes, for example, a received signal strength indicator (RSSI); a service set identifier (SSID) that identifies a wireless local area network (LAN) associated with the access point; security encryption, a domain associated with the access point; and the access point load and capability.

Based on the beacon report, access point 102 identifies candidate access points. In one embodiment, candidate access points are a predefined quantity of access points, for example, the first three access points in the ordered neighbor report. Based on the ordering of the neighbor report, mobile device 110 is most likely to connect to one of the candidate access points. In some embodiments, the candidate access points are also prioritized based on how likely each candidate access point is to connect to mobile device 110. Mobile device 110 is therefore likely to connect to the candidate access points according to the assigned priority. For example, mobile device 110 is likely to connect to the highest priority candidate access point.

Access point 102 sends a predefined number of mobile device's 110 communications sessions to the candidate access points. Considering that mobile device 110 can only attach to one of the candidate access points, the predefined number of communications sessions transmitted to the candidate access points is configurable to efficiently support the mobile device's anticipated movement, without overburdening those candidate access points to whom the mobile device will not actually connect. In some embodiments, the predefined number of communications sessions is configured to include only those communications sessions that are essential to handover of mobile device 110. For example, the predefined communications sessions may include voice communications sessions and other communications sessions that are sensitive to latency. In some embodiments, the predefined communications sessions may include all of the mobile device's 110 communications sessions.

Thereafter, when mobile device 110 begins to roam to geographical area 122, mobile device 110 is configured to send a neighbor request to access point 102. The neighbor request is a query from mobile device 110 to access point 102 for a list of access points that in the communication range of the mobile device. Access point 102 responds to mobile device 110 by sending the ordered neighbor report with the prioritized list of candidate access points. When mobile device 110 roams to one of the candidate access points, if access point 102 previously sent only a subset of the mobile device's communications sessions to the candidate access points, access point 102 is configured to transmit the remaining communications sessions for the mobile device to the access point to whom the mobile device is connected. In this example, if mobile device 110 roams and connects to access point 104 because it has the highest priority in the list of prioritized candidate access points, access point 104 is configured to provide services to mobile device 110 without any delays. Roaming delays associated with providing services to mobile device 110 are therefore minimized, or in some cases eliminated, because access point 104 would have already received the session information for mobile device 110 before mobile device 110 connects to access point 104.

In some embodiments, when mobile device 110 successfully roams to access point 104, access point 104 sends out a notification to other access points in WLAN 100. The notification may be, for example, a multicast notification to other access points located a predefined distance from access point 104. Upon receiving the notification that mobile device 110 has roamed to another access point, the other access points in the list of candidate access points are configured to delete the session information for mobile device 110.

In some cases, mobile device 110 may not roam to any of the candidate access points. In addition, one or more candidate access points may not receive the notification that mobile device 110 has connected to another candidate access point. Therefore, each of the access points is configured with a time-out mechanism. The time-out mechanism provides a means for each access point to delete communications sessions associated with mobile devices that are not connected to the access point after a predefined time period. For example, in each candidate access point, when communications sessions associated with mobile device 110 are received, mobile device 110 is added to a list of devices that are expected to associate with the candidate access point and an associated time-out mechanism is set. When the period associated with the time-out mechanism expires, if mobile device 110 is not connected to the candidate access point, the candidate access point deletes the communications sessions associated with mobile device 110.

In some situations, mobile device 110 may roam to access point 104 after the time-out mechanism expires. To ensure continuation of the communications session with mobile device 110, access point 102 is configured to still transmit the mobile device's communications sessions to access point 104 after it receives a notification from access point 104 that mobile device 102 is now attached to access point 104. It should be noted that if mobile device 110 connects to an access point before the access point receives the associated session information for mobile device 110, a delay will be associated with transmission of the session information.

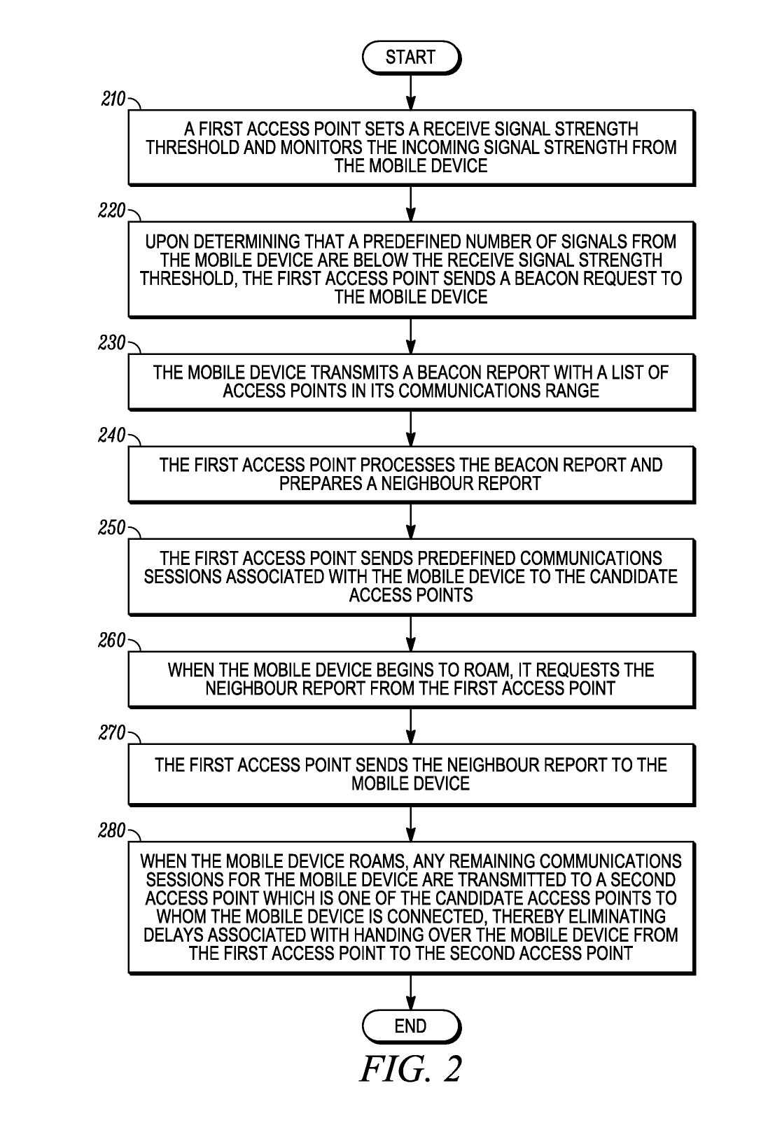

FIG. 2 is a flowchart of a method for predicting movement of a mobile device from one WLAN coverage area to another. In 210, a first access point sets a receive signal strength threshold and monitors the incoming signal strength from the mobile device. In 220, upon determining that a predefined number of signals from the mobile device are below the receive signal strength threshold, the first access point sends a beacon request to the mobile device. In 230, the mobile device transmits a beacon report with a list of access points in its communications range. In 240, the first access point processes the beacon report and prepares a neighbor report, wherein those access points to whom the mobile device is most likely to connect are identified as candidate access points and prioritized in the neighbor report. In 250, the first access point sends predefined communications sessions associated with the mobile device to the candidate access points. In 260, when the mobile device begins to roam, it requests the neighbor report from the first access point. In 270, the first access point sends the neighbor report to the mobile device. In 280, when the mobile device roams, any remaining communications sessions for the mobile device are transmitted to a second access point which is one of the candidate access points to whom the mobile device is connected, thereby seamlessly handing over the mobile device from the first access point to the second access point.

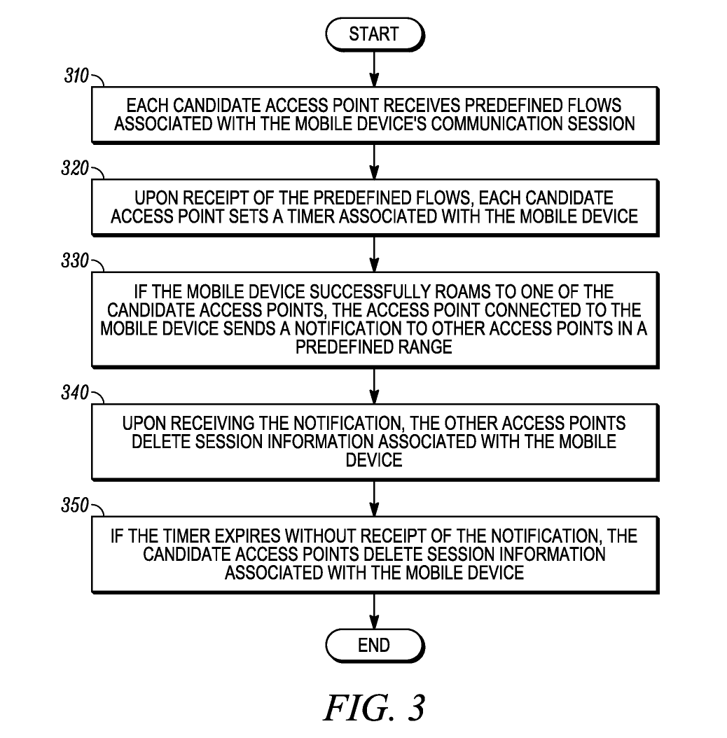

FIG. 3 is a flowchart of a method for processing information associated with a roaming mobile device at candidate access points in accordance with some embodiments. In 310, each candidate assess point receives predefined communications sessions associated with the mobile device. In 320, upon receipt of the predefined communications sessions, each candidate access point sets a timer associated with the mobile device. In 330, if the mobile device successfully roams to one of the candidate access points, the access point connected to the mobile device sends a notification to other access points in the network. In 340, upon receiving the notification, the other access points delete communications sessions associated with the mobile device. In 350, if the timer expires without receipt of the notification, the candidate access points delete communications sessions associated with the mobile device.

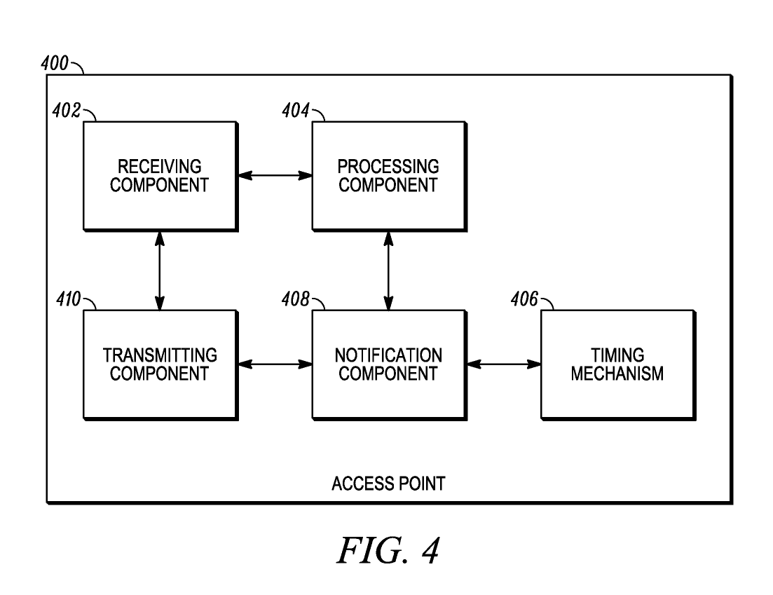

FIG. 4 is a block diagram of an access point used in accordance with some embodiments. The arrows in FIG. 4 are intended to show that components communicate with each other either directly or through other components. Access point 400 includes a receiving component 402 which is configured to receive information from mobile devices and communications sessions associated with mobile devices from other access point. Access point 400 also includes a processing component 404 which is configured to predict that a mobile device in an associated coverage area is about to roam to another coverage area. Processing component 404 is also configured to identify candidate access points to whom the mobile device can potentially connect after the mobile device leaves the associated coverage area. Access point 400 further includes a transmitting component 410 which is configured to transmit a predefined number of communications sessions for the mobile device to the candidate access points. After receipt of a request for a neighbor report from the mobile device, transmitting component 410 is configured to transmit the neighbor report to the mobile device. Transmitting component 410 is also configured to transmit any remaining communications sessions for the mobile device to another access point which is one of the candidate access points that is currently connected to the mobile device, thereby eliminating delays associated with transmitting session information from access point 400. Access point 400 also includes a timing mechanism 406 which is configured to define a connection period during which the mobile device can connect to access point 400. A notification component 408 associated with timing mechanism is configured to notify other access points when the mobile device connects to access point 400 during the connection period. It should be appreciated that other components of access point 400 are not shown for the sake of simplicity.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for seamlessly handing over a mobile device from one access point to another access point in a wireless network comprising:
predicting, by a first access point, future movement of a mobile device from an associated coverage area to another coverage area within a predefined time period;
identifying, by the first access point, candidate access points to whom the mobile device can connect after the mobile device leaves the associated coverage area and sending a predefined number of communications sessions for the mobile device to the candidate access points; and
transmitting, by the first access point, a neighbor report to the mobile device in response to indication of movement by the mobile device to the other coverage area and, when the mobile device roams, transmitting any remaining communications sessions for the mobile device to a second access point which is one of the candidate access points to whom the mobile device is connected, thereby seamlessly handing over the mobile device from the first access point to the second access point.

2. The method of claim 1, wherein when the mobile device connects to the second access point, the second access point sends a notification to other access points.

3. The method of claim 2, wherein upon receipt of the notification, all candidate access points except the second access point delete communications sessions associated with the mobile device.

4. The method of claim 1, wherein each candidate access point sets a timer upon receipt of the predefined number of communications sessions for the mobile device and deletes the predefined number of communications sessions for the mobile device upon expiration of a period associated with the timer.

5. The method of claim 1, wherein the transmitting comprises responding, by the first access point, to a received request for the neighbor report from the mobile device.

6. The method of claim 1, wherein the identifying comprises transmitting, by the first access point, a beacon request to the mobile device to obtain a list of access points in the mobile device communications range.

7. The method of claim 6, further comprising including, by the first access point, the list of access points obtained in response to the beacon request in the neighbor report.

8. The method of claim 7, further comprising ordering, by the first access point, the neighbor report according to information associated with each access point in the list, wherein the candidate access points are a predefined quantity of prioritized access points in the list.

9. The method of claim 1, further comprising configuring, by the first access point, the predefined number of communications sessions for the mobile device depending on network activities.

10. The method of claim 1, further comprising configuring, by the first access point, the predefined number of communications sessions for the mobile device to include messages associated with latency sensitive protocols.

11. The method of claim 1, wherein the predicting comprises determining, by the first access point, that signals received from the mobile device for a predefined number of packets are below a threshold.

12. The method of claim 11, wherein the predicting comprises determining, by the first access point, that an intermediate signal received from the mobile device is higher than the threshold and resetting a count associated with determining that received signals from the mobile device for the predefined number of packets are below the threshold.

13. An access point configured to seamlessly handover a mobile device to another access point in a wireless network, comprising:
a receiving component configured to receive signals from a mobile device in an associated coverage area;
a processing component configured to predict future movement of the mobile device to another coverage area within a predefined time period and to identify candidate access points to whom the mobile device can connect after the mobile device leaves the associated coverage area; and
a transmitting component configured to transmit a predefined number of communications sessions for the mobile device to the candidate access points, to transmit a neighbor report to the mobile device in response to a request from the mobile device, and to transmit any remaining communications sessions for the mobile device to one of the candidate access points to whom the mobile device is connected, thereby seamlessly handing over the mobile device.

14. The access point of claim 13, wherein the transmitting component is configured to transmit a beacon request to the mobile device to obtain a list of access points in the mobile device communications range.

15. The access point of claim 14, wherein the processing component is further configured to include the list of access points in the mobile device communications range in the neighbor report.

16. The access point of claim 15, wherein the processing component is configured to order the neighbor report according to information associated with each access point in the list, wherein the candidate access points are a predefined quantity of prioritized access points in the list.

17. The access point of claim 13, wherein the processing component is configured to predict that the mobile device future movement by determining that signals received from the mobile device for a predefined number of packets are below a threshold.

18. The access point of claim 17, wherein the processing component is configured to determine that an intermediate signal received from the mobile device is higher than the threshold and to reset a count associated with determining that signals received from the mobile device for the predefined number of packets are below the threshold.

19. The access point of claim 13, wherein the receiving component is configured to receive communications sessions for a roaming mobile device from another access point connected to the roaming mobile device.

20. The access point of claim 13, further comprising;
a timing mechanism configured to define a connection period during which a roaming mobile device can connect to the access point; and
a notification component configured to notify other access points when the mobile device connects to the access point during the connection period, wherein upon connection to the mobile device the access point is configured to provide service to the mobile device by using previously received communications sessions, and
wherein the access point is configured to delete communications sessions for the mobile device if the mobile device is not connected to the access point at expiration of the connection period.
